(19) United States
(12) Patent Application Publication
(10) Pub. No.: US 2016/0352141 A1
(43) Pub. Date: Dec. 1, 2016

(54) INTEGRATED UPS POWER SUPPLY SYSTEM

(71) Applicants: Win Sheng Cheng, Cupertino, CA (US); Jeff Yeu-Farn Hsieh, Los Altos, CA (US); YiChien Hwang, Fremont, CA (US)

(72) Inventors: Win Sheng Cheng, Cupertino, CA (US); Jeff Yeu-Farn Hsieh, Los Altos, CA (US); YiChien Hwang, Fremont, CA (US)

(21) Appl. No.: 14/726,791

(22) Filed: Jun. 1, 2015

(51) Int. Cl. H02J 9/06; H02J 7/00

(52) U.S. Cl. CPC H02J 9/061; H02J 7/0068; H02J 7/0077

(57) ABSTRACT

Disclosed herein is an integrated direct-current based uninterrupted power supply system connected to an AC power input and a server or a computer, comprising: an AC adapter/charger unit for providing power the system and charging an energy storage unit; the energy store unit for monitoring, controlling and powering the system, and communicating the powering & battery capacity status with the server or computer, and a DC-to-DC converter circuit for providing multiple DC voltage rails.

### CROSS REFERENCE TO RELATED APPLICATION

The present application claims benefit of priority under 35 U.S.C. 119(e) to: U.S. Patent Application 62/006,873, entitled “Integrated UPS Power Supply System” and filed Jun. 2, 2014. The foregoing application is hereby incorporated by reference into the present application in its entirety.

### FIELD OF THE INVENTION

The present invention described herein relate generally to a power supply system. More specifically, the present invention described herein relates generally an integrated direct-current based uninterrupted power supply system (“Integrated UPS power supply system” hereinafter) for the computers, and/or servers.

### BACKGROUND

In the conventional computer(s), the power supply directly comes from the AC power socket. The AC power is then converted through ATX power supply to multiple DC voltage rails, including the ranges of 12V, 5V, 3.3V, and −12V. These voltages rails are used to power different components and peripherals and then generate even lower voltages rails to power the CPU, DRAM and system chipset on the server's main board. Therefore, conventional UPS systems are designed to support legacy power supplies by storing energy outside of the server or computer unit and convert the battery-based DC voltage to AC electricity to be fed to the AC power supplies. Normally the DC to AC inversion is not efficient due the voltage differences and the inverter design. For UPS in data center, it is normally centralized to support all the servers or computers. The manufacturing of the conventional centralized UPS system can very costly, resulting in more complicated issues and manpower to repair, support and maintain the system.

The current integrated UPS power supply system can overcome the sizing limitations and enhance the efficiency of the conventional UPS system. The energy storage unit of the current invention can be designed and be positioned inside the computer and/or server, and replacing the energy inefficient standard ATX power supply unit with a more efficient AC adapter and related DC-DC converters. Therefore, the overall size of the conventional UPS power supply system can be significantly reduced. Moreover, battery capacity can be tailored to meet the requirements of the power demands of each computing environment more flexibly with either integrated or as expansion unit externally. The current invention can achieve higher energy efficiency, reduces cost, facilitates maintenance and prolongs the batteries running time. The current Integrated UPS power supply system can apply to the conventional and varied data centers, enterprise server farms and other computing environments.

The current invention can improve overall system efficiency by allowing the system to use less energy and space. The current invention reduces the electricity required to cool housing facilities. The built-in energy storage unit can be easily and efficiently charged from green energy sources such as solar panel, wind turbine or other latest energy power sources such as fuel cells engine, and from conventional energy sources such as diesel engines. The energy storage unit built-in to a server/computer can also be linked, in parallel connectivity, to energy storage units in other servers/computers making it effectively a larger energy storage system. This provides a large pool of energy in which different servers/computers with different energy needs can draw upon. This prevents certain critical servers to run out of battery earlier than non-critical servers. The storage capacity and system health of energy storage unit can be monitored by server/computer and then back to computer networks.

The current invention provides a scalable computing environment to simplify the routine service and maintenance in the battery and power supply system. The conventional UPS system in data center or server farm, generally called the centralized UPS system, usually requires periodic maintenance that will either put the system from corresponding computing resources into standby or powered down or activate a duplicated UPS system. This requires significant amount of time and cost. Our current invention provides a decentralized UPS system which provides less maintenance cycles on a rotational basis. The current design can provide more power efficiency while having less downtime and redundancy. The current invention provides an integrated, compact, and more power efficient power supply system that can generally avoids the traditional bulky to fit a variety of user's needs.

### SUMMARY

Disclosed herein is an integrated UPS power supply system connected to an AC power input and a server or a computer, comprising: an AC adapter/charger unit for providing power to the system and charging an energy storage unit; the energy store unit for monitoring/controlling and powering the system, and communicating the powering & battery capacity status with the server or computer, and a DC-to-DC converter circuit for providing multiple DC voltage rails.

Disclosed herein is an integrated UPS power supply system connected to an AC power input and a server or a computer, comprising: an AC adapter/charger unit for providing power to the system and charging the energy store unit; the energy store unit for detecting the power outage from the system, disabling the AC adapter charger, and enabling server or computer to remain or enter in a lower power mode, and a DC-to-DC converter circuit for providing multiple DC voltage rails.

Disclosed herein is an integrated power supply system connected to an AC power input and a server or a computer, comprising: an AC adapter charger unit for providing power the system and charging an energy storage unit; a DC-to-DC converter circuit for providing multiple DC voltage rails, and an energy store unit for detecting the low power in a predetermined minimum level, disabling the AC adapter charger, notifying and requesting the server computer to shut down.

Disclosed herein is an integrated power supply system connected to an AC power input and a server or a computer, comprising: an AC adapter charger unit for providing power and charging an energy storage unit; a DC-to-DC converter circuit for providing multiple DC voltage rails, and the energy store unit for monitoring, controlling and powering the system, and communicating the powering & battery capacity status with the server or computer, wherein the energy store unit comprises battery back, a microcontroller and a programmable current limit.

Disclosed herein is an integrated power supply system connected to an AC power input and a server or a computer, comprising: an AC adapter charger unit for providing power and charging an energy storage unit; a DC-to-DC converter circuit for providing multiple DC voltage rails, and the energy store unit for monitoring, controlling, powering the system, and communicating the powering & battery capacity status with the server or computer, wherein the energy store unit comprises a microcontroller, a programmable current limit, and at least one series-connected lead-acid (LA) battery pack.

Disclosed herein is an integrated power supply system connected to an AC power input and a server or a computer, comprising: an AC adapter charger unit for providing power and charging an energy storage unit a DC-to-DC converter circuit for providing multiple DC voltage rails, and the energy store unit for monitoring, controlling, powering the system, and communicating the powering & battery capacity status with the server or computer, wherein the energy store unit comprises a microcontroller, a programmable current limit, and at least one series-connected lithium-ion (Li) battery pack.

Disclosed herein is an integrated power supply system connected to an AC input supply and a server or a computer, comprising: an AC adapter charger unit for providing power and charging an energy storage unit; a DC-to-DC converter circuit for providing multiple DC voltage rails, and the energy store unit for monitoring, controlling, powering the system, and communicating the powering & battery capacity status with the server or computer, wherein the energy store unit comprises a microcontroller, a programmable current limit, and the combinations of at least one series-connected lead-acid (LA) battery pack and at least one series-connected lithium-ion (Li) battery pack.

Disclosed herein is an integrated power supply system connected to an AC input supply and a server or a computer, comprising: a DC-to-DC converter circuit for providing multiple DC voltage rails, and an integrated AC adapter/charger and energy storage unit, comprising: an AC adapter/charger unit for providing power and charging an energy storage unit; and an energy store unit for monitoring and controlling the remaining power supply to the system, and communicating the power supply status with the server or computer.

Disclosed herein is a method of supplying uninterrupted power connected to the computer or server, comprising: (a) providing power and charging an energy storage unit; (b) controlling, powering the system and communicating the powering & battery capacity status with the server or computer; and (c) integrating multiple DC voltage rails DC-to-DC converter circuit to the main board of computer or server.

Disclosed herein is a method of supplying uninterrupted power to the computer or server, comprising: (a) providing power and charging an energy storage unit; (b) providing multiple DC voltage rails; and (c) detecting the available low power in a predetermined minimum level, disabling the power, notifying and requesting the server computer to shut down.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an illustration of the conventional UPS power supply system.

FIG. 2 is an illustration of the integrated UPS power supply system.

FIG. 3 is an illustration of the part of the integrated UPS power supply system in the recovery mode.

FIG. 4 is a flowchart representation of the power depletion mode of the current invention.

FIG. 5 is an illustration of another embodiment of integrated UPS power supply system.

FIG. 6 is an illustration of another embodiment of integrated UPS power supply system.

FIG. 7 is an illustration of another embodiment of integrated UPS power supply system.

### DETAILED DESCRIPTION

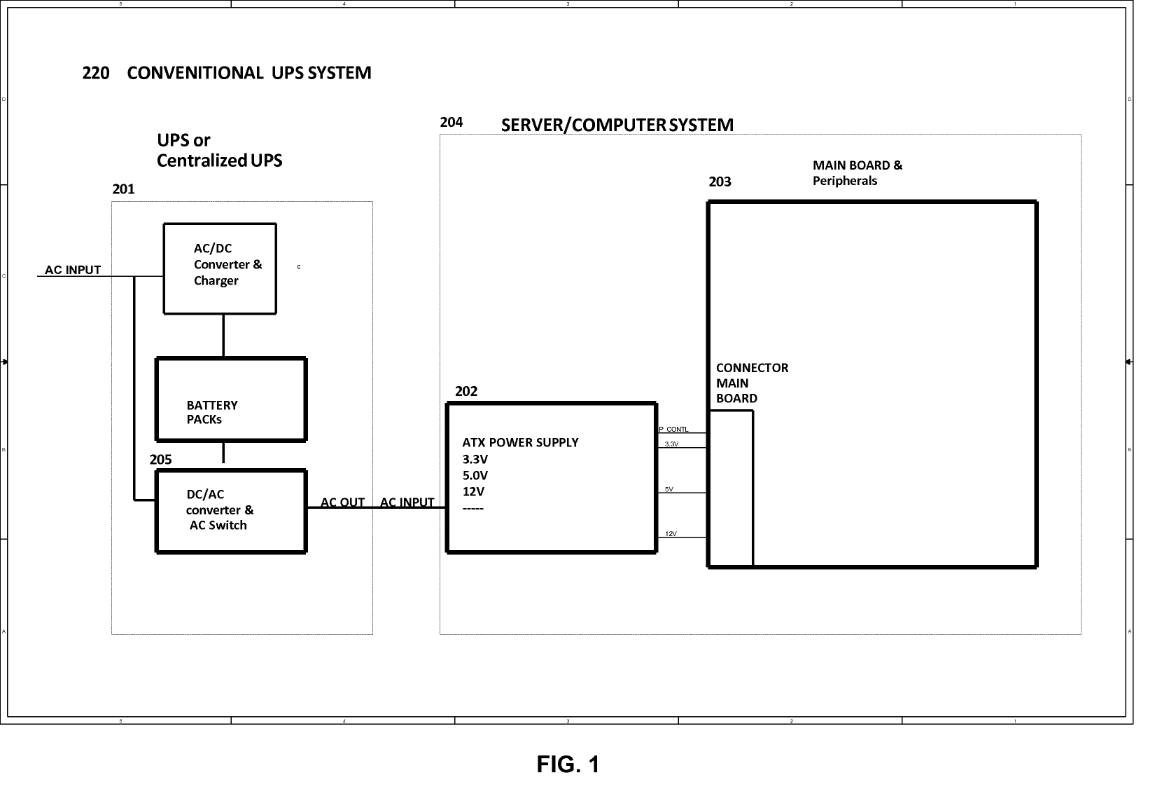

FIG. 1 shows a conventional UPS system 201. The system 201 can have some drawbacks that the energy power efficiency will be reduced significantly through two stages. Firstly, the energy is sent to the DC to AC converter 205. Secondly, the energy is sent from the AC to the standard ATX power supply 202. Each stage can cause up to 10-20% of energy lost in heat. In addition, the standard ATX power supply uses different voltage rails architecture than the single voltage AC adapters to convert AC to DC electricity. The conventional UPS system can lose up to 20-30% energy efficiency.

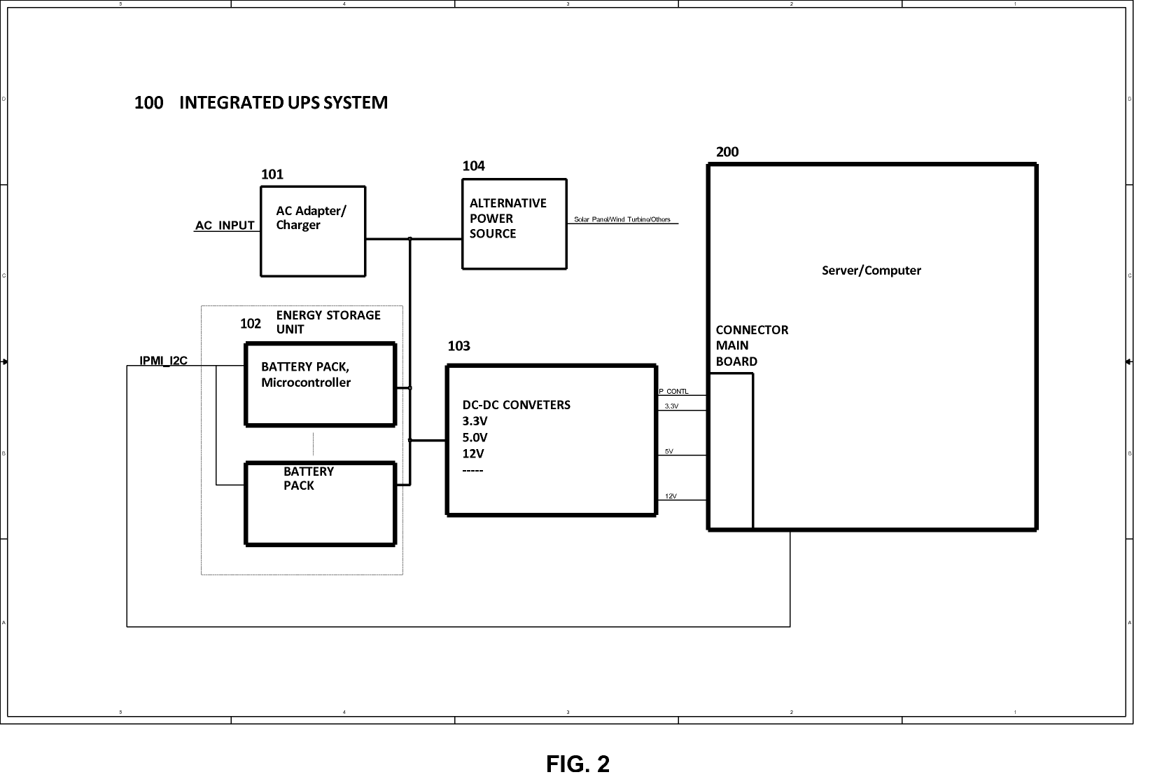

FIG. 2 describes the current invention, an integrated UPS power system 100 that connects to an AC power source and outputs DC power to the server. The energy storage unit 102 can be positioned inside the same mechanical chassis of the server/computer 200 or close to it thereof in order to reduce the length of the power wiring connected to the server/computer 200. The integrated UPS power system 100 is comprised of an AC adapter/charger 101, an energy storage unit 102, and a DC-to-DC converter circuit 103. The DC-to-DC converter circuit 103 is to provide multiple DC voltage rails to the sever/computer 200.

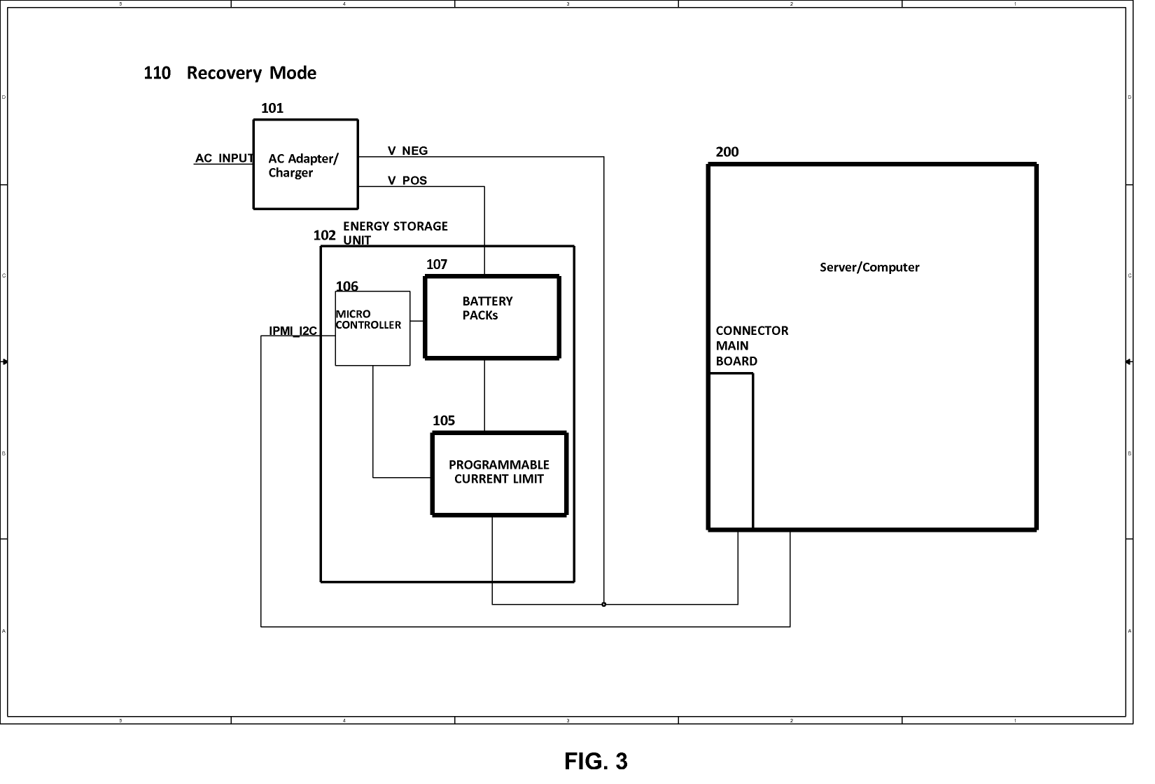

In FIG. 3, the energy storage unit 102 comprises at least one unit of battery packs 107, a microcontroller 106, and a programmable current limit 105. The battery packs 107 comprise at least one battery pack in any type of battery chemistries or combined. Examples of the battery types include, but not limit to, the lead-acid chemistry, lithium-ion chemistry, the combinations thereof, or other conventional battery chemistries. Based on power requirement, the integrated UPS power system 100 can also connect to one or more external energy storage units 102.

In FIG. 2, the integrated UPS power system 100 comprises an alternative power source 104. This feature serves as an extra power source in addition to the AC adapter/charge 101. The alternative power source 104 comprises a programmable power converter system that provides voltage or current conversion, filtering, and control from outside energy source. In another embodiment, the alternative power source 104 comprises an MPPT (“maximum power point tracking”) for converting the powers acquired from the outside energy sources. The outside power sources can include, but not limit to, the data center or cloud application, the green technologies including the solar panels, wind electricity, fuel electricity, etc. In another embodiment, the alternative power source 104 comprises an MPPT and a microcontroller for programming the voltage or current conversion from outside sources.

The AC adapter/charger 101 connects directly to the AC power source and outputs the voltage source suitable for charging the energy storage unit 102 and for powering the DC-to-DC converter circuit 103. The energy storage unit 102 monitors the charging voltage and current decides when to stop the charging. The DC-to-DC converter circuit 103 provides multiple DC voltages to power the server main board.

Intelligence is implemented in the integrated UPS system 100 to communicate with the PC server/computer 200 to collaborate on the overall energy usage plan. The energy usage plan of the current system 100 comprises the following three operation scenarios, the normal operation, the stage of power outage, and the recovery mode.

In the normal operation, the AC adapter charger 101 serves as the power source for the server/computer 200 and also charge the energy storage unit 102.

During the power outage, there is no AC power and the AC adapter 101 is disabled. The energy storage unit 102 provides power to the server/computer 200, which may work under a lower power mode to extend the battery backup time. The power outage is communicated to the server 200 by the energy storage unit 102 when it detects that the AC adapter 101 is not providing the power.

FIG. 3 shows the recovery mode 110, wherein the external AC power is back and AC adapter/charger 101 now provides sufficient energy to power the server 200 and charge the energy storage unit 102. To minimize the AC adapter output capacity and to alleviate the design requirements of the AC adapter, the charging current will be optimally controlled. A special programmable current limit 105 is built into the energy storage unit 102. The server/computer 200 also can communicate the energy storage unit 102 through built-in microcontroller 106 to inform how much current it actually needs so the energy storage unit 102 can decide to provide more current to charge the battery packs 107 inside energy storage unit 102. For normal design, the AC adapter only supplies about 30% to 40% more current than server/computer system 200 requires. Therefore, only 30% to 40% current will be used to charge the energy storage unit 102. But under some operation condition, such as server/computer 200 either in idle state or sleep mode, the server/computer 200 will not need the original assigned maximum power, so server/computer 200 can inform energy storage unit 102 through microcontroller 106. The microcontroller 106 can control programmable current limit 105 to increase the charging current from AC adapter/charger 101, hence the charging time can be reduced without increasing the rated capacity of AC adapter/charger 101. This communication can happen dynamically through IPMI (“Intelligent Platform Management Interface”) normally used in server/computer control interface system or other interface system.

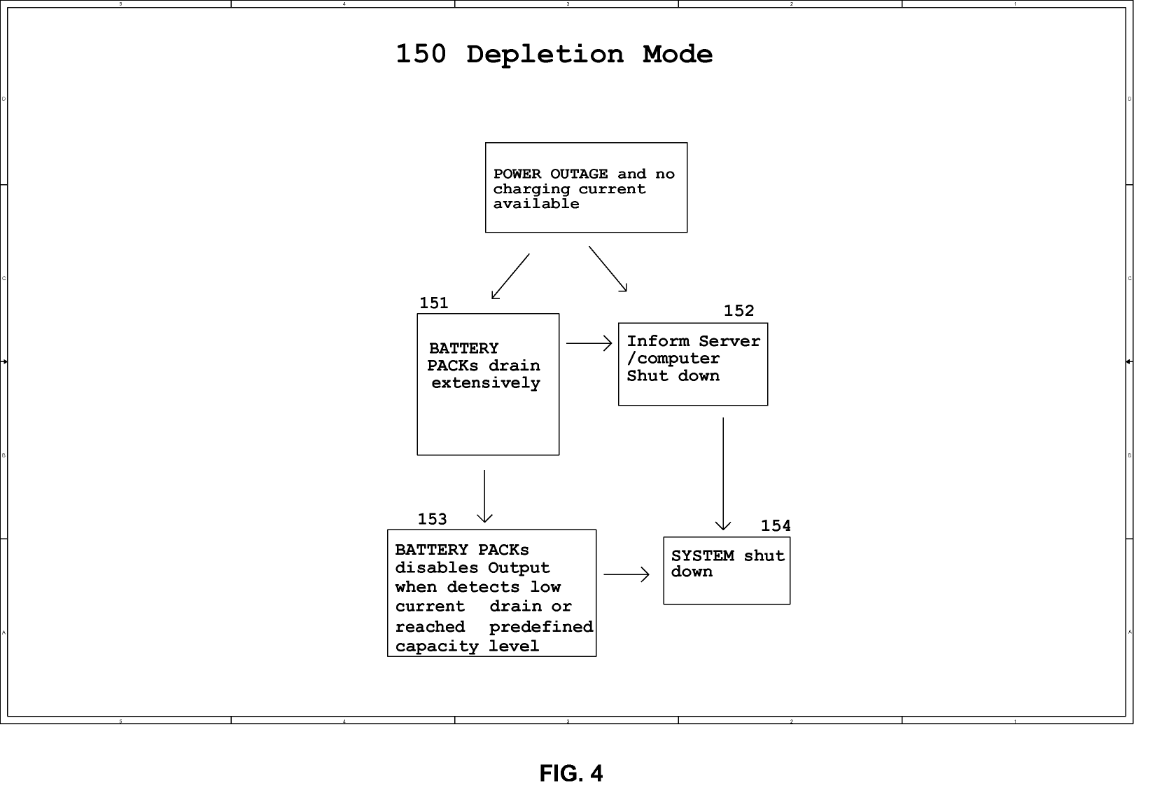

FIG. 4 shows the flowchart of the energy depletion mode of the integrated UPS power supply system 100. Block 151 shows when the energy storage unit is depleted extensively to a preset low power mode during power outage and the charging current is not immediately available. The integrated UPS power supply system 100 makes the following two commands. First, as shown in Block 152, the integrated UPS power supply system 100 notifies the server/computer 200 to take proper action. In Block 154, the server/computer 200 performs system shut down accordingly. As shown in Block 153, the integrated UPS power supply system 100 then disable the power output as detecting the low current drainage due to the server/computer shutdown. Second, the energy store unit 102 detects the overall energy down to a minimum predetermined capacity level and server/computer still not responds, it also disables its power output. When the AC power resumes, the integrated UPS power supply system 100 will then switch back to its normal operation.

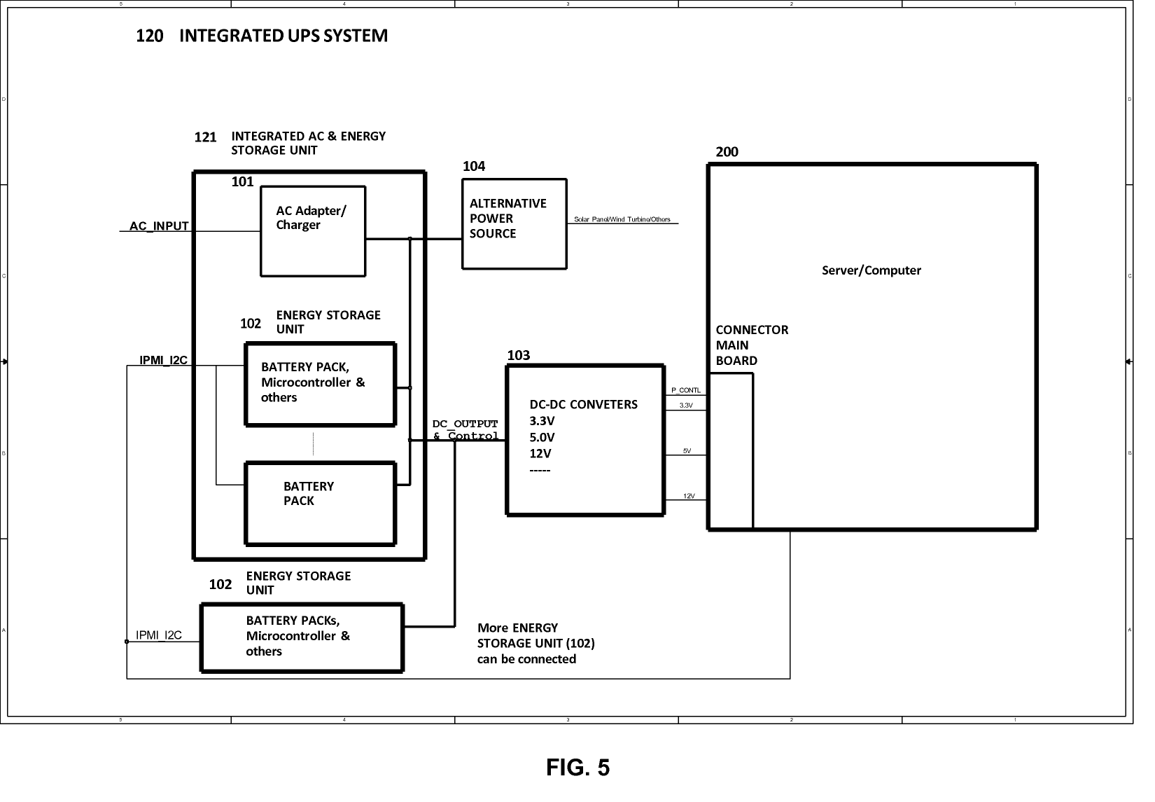

FIG. 5 shows another embodiment the integrated UPS power system 120 that connects to an AC power source and outputs DC power to the server. The integrated UPS power system 120 is comprised of an integrated AC & energy storage unit 121, and a DC-to-DC converter circuit 103. The integrated AC & energy storage unit 121 comprises an AC adapter/charger 101, and an energy storage unit 102 to minimize the design components for some application, the system may not need higher power capacity, so the size of AC adapter charger 101 and energy storage unit 102 is minimized.

In FIGS. 3 & 5, the energy storage unit 102 comprises at least one battery packs 107, a microcontroller 106, and a programmable current limit 105. The battery packs 107 comprises at least one series-connected lead-acid (LA) battery pack, at least one series-connected lithium-ion (Li) battery pack, and the combinations of at least one series-connected lead-acid (LA) battery pack and at least one series-connected lithium-ion (Li) battery pack. Based on the user's needs in the design of energy supply, the integrated UPS power system 120 can also connect to an external energy storage unit 102.

In FIG. 5, the integrated UPS power system 120 comprises an alternative power source 104. This feature serves as an extra power source in addition to the AC adapter charge 101. The alternative power source 104 comprises a programmable power converter system that provides voltage or current conversion, filtering, and control from outside energy source. In another embodiment, the alternative power source 104 comprises an MPPT (“maximum power point tracking”) for converting the powers acquired from the outside energy sources. The outside power sources can include, but not limit to, the data center or cloud application, the green technologies including the solar panels, wind electricity, fuel electricity, etc. In another embodiment, the alternative power source 104 comprises an MPPT and a microcontroller for programming the voltage or current conversion from outside sources.

The integrated AC & energy storage unit 121 comprising the AC adapter 101 connects directly to the AC power source and outputs one voltage rail suitable for charging the energy storage unit 102 and for powering the DC-to-DC converter circuit 103. The energy storage unit 102 of the integrated AC and energy storage unit 121 monitors the charging voltage and decides whether to accept the charge. The DC-to-DC converter circuit 103 provides multiple DC voltages to power the server main board including the standard ATX power supply.

Intelligence is implemented in the integrated UPS system 120 to communicate with the PC server/computer 200 to collaborate on the overall energy usage plan. The energy usage plan of the current system 120 comprises the following three operation scenarios, including the normal operation, the stage of power outage, and the recovery mode.

In the normal operation status, the AC adapter serves as the main power source for the server/computer 200 and then for charging the energy storage unit 102 inside the integrated AC & energy storage unit 121.

During the stage of power outage, the AC adapter 101 is disabled. The energy storage unit 102 provides power to the server/computer 200, which may work under a lower power mode to extend the battery backup time. The low power mode is communicated to the server 200 by the integrated UPS power supply system 100 when it detects that the AC adapter 101 is not providing the power.

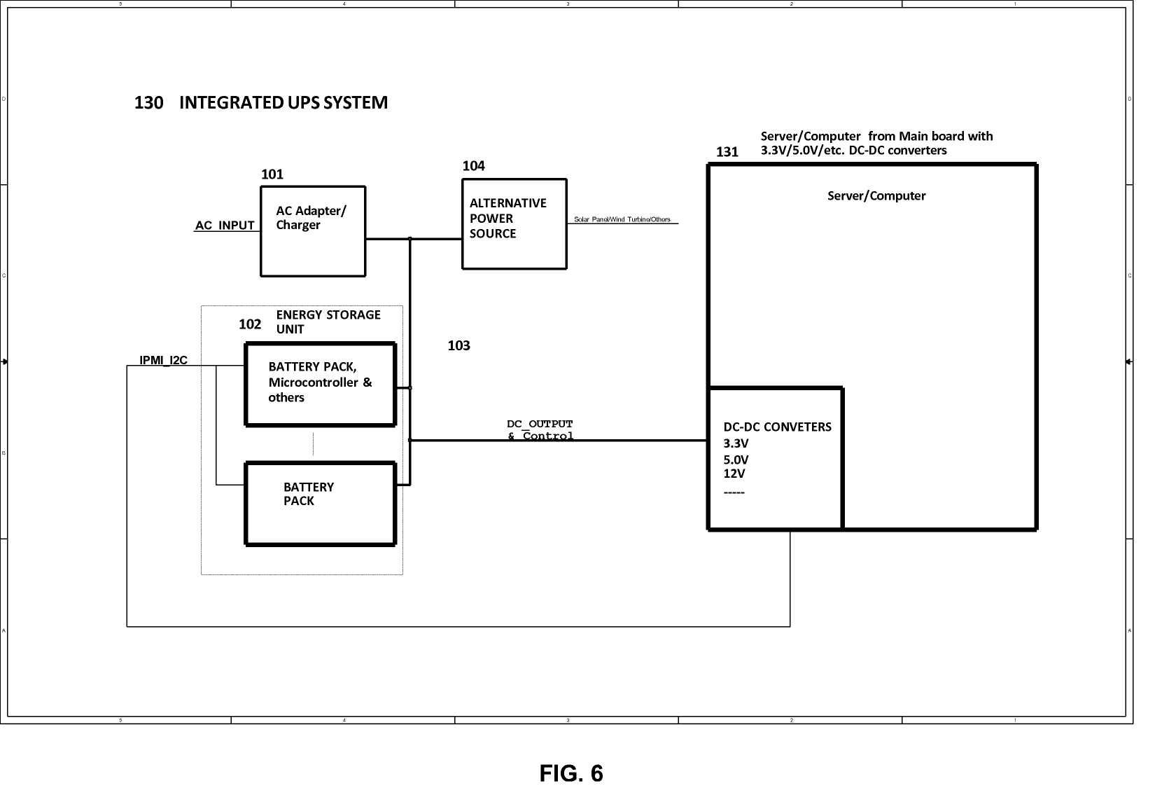

FIG. 6 shows another embodiment the integrated UPS power system 130 that connects toan AC power source and outputs DC power to the server. The integrated UPS power system 130 is comprised of a AC adapter/charger 101, an energy storage unit 102, and sever computer assembly 131 comprises a DC-to-DC converter circuit 103 integrated inside main board of the server/computer 131.

In FIG. 6, the integrated UPS power system 130 comprises an alternative power source 104. This feature serves as an extra power source in addition to the AC adapter charge 101. The alternative power source 104 comprises a programmable power converter system that provides voltage or current conversion, filtering, and control from outside energy source. In another embodiment, the alternative power source 104 comprises an MPPT (“maximum power point tracking”) for converting the powers acquired from the outside energy sources. The outside power sources can include, but not limit to, the data center or cloud application, the green technologies including the solar panels, wind electricity, fuel electricity, etc. In another embodiment, the alternative power source 104 comprises an MPPT and a microcontroller for programming the voltage or current conversion from outside sources.

Intelligence is implemented in the integrated UPS system 130 to communicate with the server computer assembly 131 to collaborate on the overall energy usage plan. The energy usage plan of the current system 130 comprises the following three operation scenarios, including the normal operation, the stage of power outage, and the recovery mode.

In the normal operation status, the AC adapter serves as the main power source for the server computer assembly 131 and then for charging the energy storage unit 102.

During the stage of power outage, the AC adapter 101 is disabled. The energy storage unit 102 provides power to the server/computer 200, which may work under a lower power mode to extend the battery backup time. The low power mode is communicated to the server computer assembly 131 by the integrated UPS power supply system 130 when it detects that the AC adapter 101 is not providing the power.

FIGS. 3 & 6 show the recovery mode 110 of the integrated UPS power supply system 130, wherein the external power is back online and AC adapter 101 now provides sufficient energy to power the server computer assembly 131 and charge the energy storage unit 102. To minimize the AC adapter output capacity and to alleviate the design requirements of the AC adapter, the charging current will be optimally controlled. A special programmable current limit 105 is built into energy storage unit. The server computer assembly 131 also can communicate the energy storage unit 102 through built-in microcontroller 106 to inform how much current it actually needs so the storage unit can decide to provide more current to charge the battery packs 107 inside energy storage unit 102. For normal design, the AC adapter only supplies about 30% to 40% more current than server/computer system 200 requires. Therefore, only 30% to 40% current will be used to charge the energy storage unit 102. But under some operation condition, such as server computer assembly 131 either in idle state or sleep mode, the server computer assembly 131 will not need the original assigned maximum power, so the server computer assembly 131 can inform energy storage unit 102 through microcontroller 106. The microcontroller 106 can control programmable current limit 105 to increase the charging current from AC adapter/Charger 101, hence the charging time can be reduced without increasing the rated capacity of AC adapter/charger 101. This communication can happen dynamically through IPMI normally used in server/computer control interface system.

FIGS. 4 & 6 show the flowchart of the energy depletion mode of the integrated UPS power supply system 130. Block 151 shows when the energy storage unit is depleted extensively during power outage and the charging current is not immediately available. The integrated UPS power supply system 130 will cut off the output power in order to protect the life of the internal battery packs inside the energy storage unit 102 and to prevent from further damages. The UPS power supply system 130 makes the following two commands. First, as shown in Block 152, the UPS power supply system 130 notifies the server/computer 200 to take proper action. The action includes shutting down the UPS power supply system 130. In Block 154, the server/computer 200 commands the UPS power supply system 130 to shut down. The USP power supply system 130 is then automatically and completely shut down in order to avoid complete power drainage. Second, as shown in Block 151, the energy store unit 102 can detect the situations when the internal battery packs have been drained extensively showing the low current drainage. The energy store unit 102 can also detect when the overall energy lowers down to a minimum predetermined capacity level. The energy store unit 102 sends data and/or signals to the server computer assembly 131. In Block 153, the energy store unit 102 disables the output supply. When the AC power resumes, the energy storage unit 102 is recharged sufficiently. The integrated UPS power supply system 130 will then switch back to its normal operation.

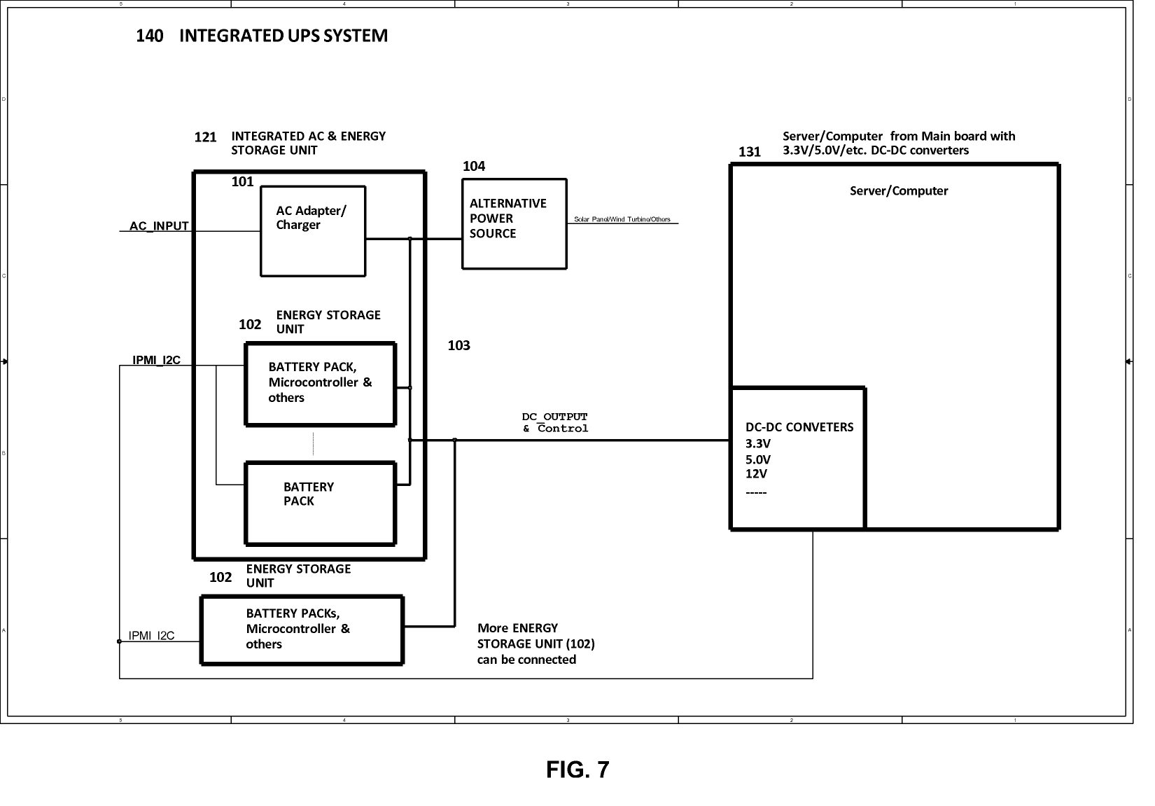

FIG. 7 shows another embodiment the integrated UPS power system 140 that connects to an AC power source and outputs DC power to the server. The integrated UPS power system 130 is comprised of an integrated AC & energy storage unit 121, and a server computer assembly 131. The integrated AC & energy storage unit 121 comprises an AC adapter/charger 101 and an energy storage unit 102. The sever computer assembly 131 comprises a DC-to-DC converter circuit 103 integrated into main board of the server computer 131.

In FIGS. 3 & 7, the energy storage unit 102 comprises at least one battery packs 107, a microcontroller 106, and a programmable current limit 105. The battery packs 107 comprises at least one series-connected lead-acid (LA) battery pack, at least one series-connected lithium-ion (Li) battery pack, and the combinations of at least one series-connected lead-acid (LA) battery pack and at least one series-connected lithium-ion (Li) battery pack. Based on the user's needs in the design of energy supply, the integrated UPS power system 100 can also connect to an external energy storage unit 102.

In FIG. 7, the integrated UPS power system 140 comprises an alternative power source 104. This feature serves as an extra power source in addition to the AC adapter charge 101. The alternative power source 104 comprises a programmable power converter system that provides voltage or current conversion, filtering, and control from outside energy source. In another embodiment, the alternative power source 104 comprises an MPPT (“maximum power point tracking”) for converting the powers acquired from the outside energy sources. The outside power sources can include, but not limit to, the data center or cloud application, the green technologies including the solar panels, wind electricity, fuel electricity, etc. In another embodiment, the alternative power source 104 comprises an MPPT and a microcontroller for programming the voltage or current conversion from outside sources.

Intelligence is implemented in the integrated UPS system 140 to communicate with the server computer assembly 131 to collaborate on the overall energy usage plan. The energy usage plan of the current system 140 comprises the following three operation scenarios, including the normal operation, the stage of power outage, and the recovery mode.

In the normal operation status, the AC adapter serves as the main power source for the server computer assembly 131 and then for charging the integrated AC & energy storage unit 121.

As shown in FIG. 7, during the stage of power outage, the AC adapter 101 of the integrated AC & energy storage unit 121 is disabled. The energy storage unit 102 of the integrated AC & energy storage unit 121 provides power to the server computer assembly 131, which may work under a lower power mode to extend the battery backup time. The low power mode is communicated to the server computer assembly 131 by the integrated UPS power supply system 140 when it detects that the AC adapter 101 is not providing the power.

FIGS. 3 & 7 show the recovery mode 110 of the integrated UPS power supply system 140, wherein the external power is back online and AC adapter 101 now provides sufficient energy to power the server computer assembly 131 and charge the energy storage unit 102. To minimize the AC adapter output capacity and to alleviate the design requirements of the AC adapter, the charging current will be optimally controlled. A special programmable current limit 105 is built into energy storage unit. The server computer assembly 131 also can communicate the energy storage unit 102 through built-in microcontroller 106 to inform how much current it actually needs so the storage unit can decide to provide more current to charge the battery packs 107 inside energy storage unit 102. For normal design, the AC adapter only supplies about 30% to 40% more current than server/computer system 200 requires. Therefore, only 30% to 40% current will be used to charge the energy storage unit 102. But under some operation condition, such as server computer assembly 131 either in idle state or sleep mode, the server computer assembly 131 will not need the original assigned maximum power, so the server computer assembly 131 can inform energy storage unit 102 through microcontroller 106. The microcontroller 106 can control programmable current limit 105 to increase the charging current from AC adapter/Charger 101, hence the charging time can be reduced without increasing the rated capacity of AC adapter/charger 101. This communication can happen dynamically through IPMI normally used in server/computer control interface system.

FIGS. 4 & 7 show the flowchart of the energy depletion mode of the integrated UPS power supply system 140. Block 151 shows when the energy storage unit is depleted extensively during power outage and the charging current is not immediately available. The integrated UPS power supply system 140 will cut off the output power in order to protect the life of the internal battery packs inside the energy storage unit 102 of the integrated AC & energy storage unit 121 and to prevent from further damages. The UPS power supply system 140 makes the following two commands. First, as shown in Block 152, the UPS power supply system 140 notifies the server computer assembly 131 to take proper action. The action includes shutting down the UPS power supply system 140. In Block 154, the server computer assembly 131 commands the UPS power supply system 140 to shut down. The USP power supply system 140 is then automatically and completely shut down in order to avoid complete power drainage. Second, as shown in Block 151, the energy store unit 102 of the integrated AC & energy storage unit 121 can detect the situations when the internal battery packs have been drained extensively showing the low current drainage. The energy store unit 102 can also detect when the overall energy lowers down to a minimum predetermined capacity level. The energy store unit 102 sends data and/or signals to the server computer assembly 131. In Block 153, the energy store unit 102 of the integrated AC & energy storage unit 121 disables the output supply. When the AC power resumes, the energy storage unit 102 of the integrated AC & energy storage unit 121 is recharged sufficiently. The integrated UPS power supply system 140 will then switch back to its normal operation.

What is claimed is:

1. An integrated UPS power supply system connected to an AC power input and a server or a computer, comprising:
(a) an AC adapter/charger unit for providing power and charging an energy storage unit;
(b) a DC-to-DC converter circuit for providing multiple DC voltage rails; and
(c) the energy store unit for monitoring, controlling and powering the system, and communicating the powering & battery capacity status with the server or computer.

2. The energy store unit of claim 1 comprises at least one battery packs.

3. The energy store unit of claim 2, comprises a microcontroller and a programmable current limit.

4. The energy store unit of claim 3, comprises the combinations of at least one series-connected lead-acid (LA) battery pack, or at least one series-connected lithium-ion (Li) battery pack, or the combinations thereof.

5. An integrated UPS power supply system connected to an AC input and a server or a computer, comprising:
(a) an AC adapter/charger unit for providing power and charging an energy store unit;
(b) the energy store unit for detecting the power outage from the system, disabling the AC adapter charger, and enabling the server or computer to remain in a lower power mode; and
(c) a DC-to-DC converter circuit for providing multiple DC voltage rails.

6. The energy store unit of claim 5 comprises at least one battery packs.

7. The energy store unit of claim 6, comprises a microcontroller and a programmable current limit.

8. The energy store unit of claim 7 can detect the most available low power from a predetermined minimum level.

9. The energy store unit of claim 8 can notify and request the server computer to shut down and to recharge the batteries.

10. The energy store unit of claim 9, comprises the combinations of at least one series-connected lead-acid (LA) battery pack, or at least one series-connected lithium-ion (Li) battery pack, or the combinations thereof.

11. The integrated power supply system of claim 10, further comprises an alternative power source, comprising a programmable power converter system for providing the voltage or current conversion, filtering, and control from the outside energy source.

12. The integrated power supply system of claim 11 connects to at least one external energy store unit.

13. The alternative power source of claim 12 comprises an MPPT.

14. A method of supplying uninterrupted power connected to the computer or server implemented by an integrated power supply device, the integrated power supply device including an AC adapter/charger unit, a DC-to-DC converter circuit, and an energy store unit, comprising following the steps:
(a) providing power and charging the energy storage unit;
(b) controlling, powering the system and communicating the powering & battery capacity status with the server or computer; and
(c) providing multiple DC voltage rails to the computer or server.

15. The method of supplying uninterrupted power of claim 14, further contains the steps of detecting the available low power in a predetermined minimum level, disabling the power, notifying and requesting the server computer to shut down and to recharge the batteries.

16. The energy store unit of claim 14 comprises at least one battery packs.

17. The energy store unit of claim 15, comprises a microcontroller and a programmable current limit.

18. The energy store unit of claim 17 can detect the most available low power from a predetermined minimum level.

19. The energy store unit of claim 18 can notify and request the server computer to shut down and to recharge the batteries.

20. The energy store unit of claim 19, comprises the combinations of at least one series-connected lead-acid (LA) battery pack, or at least one series-connected lithium-ion (Li) battery pack, or the combinations thereof.

21. The integrated power supply system of claim 20, further comprises an alternative power source, comprising a programmable power converter system for providing the voltage or current conversion, filtering, and control from the outside energy source.
